(19) United States
(12) Patent Application Publication
(10) Pub. No.: US 2021/0293399 A1
(43) Pub. Date: Sep. 23, 2021

(54) Lighting Panel

(71) Applicant: LedHero Ltd, Retford (GB)

(72) Inventor: Nicholas John Symon Lacey, Retford (GB)

(21) Appl. No.: 17/205,319

(22) Filed: Mar. 18, 2021

(30) Foreign Application Priority Data
Mar. 19, 2020 (GB) 2004041.6

(51) Int. Cl. F21V 21/04; F21V 21/088

(52) U.S. Cl. CPC F21V 21/047; F21Y 2115/10; F21V 21/043; F21V 21/088

(57) ABSTRACT

An apparatus for providing a light source to a building includes a lighting panel that has a housing. The housing includes an outer wall having a front surface and a rear surface. The front surface defines a cavity having a light source therein. The apparatus further includes a galvanized steel cover that is securable to and configured to conform to the rear surface of the housing.

### CROSS REFERENCE TO RELATED APPLICATIONS

The present application claims priority to and the benefit of Lacey, United Kingdom Patent Application No. GB 2004041.6, filed Mar. 19, 2020, and entitled “Lighting Panel.” The entire contents of this application are incorporated herein by reference.

### FIELD OF DISCLOSURE

The present invention relates to an apparatus for providing a light source to a building, a method of manufacturing an apparatus for providing a light source to a building, and a cover securable to a lighting panel.

### BACKGROUND

Lighting panels are used in commercial and residential buildings to provide lighting to the inside of the building. Conventional lighting panels typically comprise a housing which forms the panel and supports a light source, such as a plurality of LEDs. Conventional LED panels of this type typically only meet basic fire safety standards and do not meet the standards required for certification under BS-476-22:1987—“Fire tests on building materials and structures” or EN-1364-2:2018—“Fire resistance tests for non-load bearing elements, Part 2: Ceilings”.

The housing of conventional lighting panels of this type is usually painted white, which provides an operational advantage of enabling deflection of the light from the light source to provide a necessary output. However, in the event of a fire, the paint provides a flammable material which leads to a flash fire meaning that conventional lighting panels are unsuitable while failing to meet preferred standards.

### SUMMARY

According to a first aspect of the present invention, there is provided an apparatus for providing a light source to a building, as claimed in claim 1.

According to a second aspect of the present invention, there is provided a method of manufacturing an apparatus for providing a light source to a building, as claimed in claim 13.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE DRAWINGS

FIG. 1 shows an example building having a ceiling comprising a plurality of lighting panels;

FIG. 2 shows housing of an example lighting panel in accordance with the invention;

FIG. 3 shows an alternative view of the housing of a lighting panel as previously shown in FIG. 2;

FIG. 4 shows a cover suitable for use with the lighting panel described in FIGS. 2 and 3;

FIG. 5 shows a cross sectional side view of the lighting panel and cover in accordance with the invention;

FIG. 6 shows a plan view of the cover previously described;

FIG. 7 shows a lighting panel fitted with a cover in a ceiling;

FIG. 8 shows a graph temperature change against time for a fire safety test;

FIG. 9 shows a lighting panel housing and cover to be secured together; and

FIGS. 10A and 10B show a method of securing a cover to a lighting panel housing.

### DETAILED DESCRIPTION

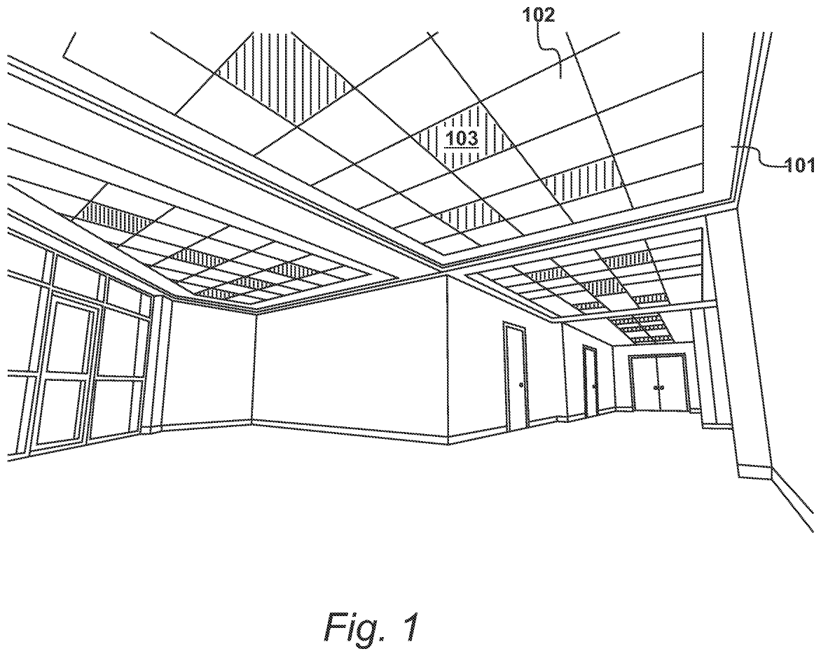

### FIG. 1

An example building having a ceiling comprising a plurality of lighting panels is shown in FIG. 1.

The building of FIG. 1 may be any suitable building utilised for any commercial, residential or other purpose requiring lighting. In the embodiment, ceiling 101 comprises a plurality of ceiling tiles, such as, for example ceiling tile 102, and a plurality of lighting panels, for example, lighting panel 103.

Lighting panel 103 is configured to provide a light source to the inside of a building in a conventional manner. Thus, one of more lighting panels may be arranged to form part of ceiling 101 to provide appropriate lighting in line with requirements.

While it is conventional to test and provide ceiling tiles and ceiling materials that meet high fire safety standards, often, conventional lighting panels do not meet the same standards as the ceiling tiles. In this way, the ceiling as a whole may not meet the appropriate fire safety standards due to the inclusion of the lighting panels.

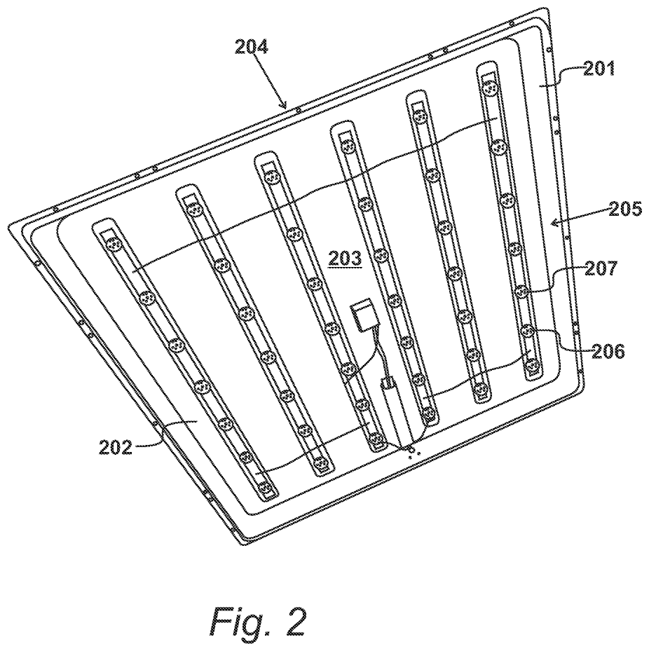

### FIG. 2

An example lighting panel in accordance with the present invention will now be described. An example lighting panel comprises a housing 201, such as that as depicted in FIG. 2.

Housing 201 comprises an outer wall 202 having a front surface 203 and a rear surface 204. Front surface 203 is substantially opposite to rear surface 204.

In the embodiment, front surface 203 comprises a cavity 205 which, as shown, comprises a light source. In the embodiment, the light source comprises a plurality of light emitting diodes (LEDs), such as LED 206 and LED 207, which are formed on a lighting strip. It is appreciated that in further embodiments, alternative light sources may be utilised. For example, in an embodiment, the light source comprises a plurality of LEDs, but these are arranged in an alternative manner rather than as a lighting strip. In a further embodiment, the light source may comprise a bulb. It is appreciated therefore that any suitable light source may be used.

In the embodiment, front surface 203 and rear surface 204 comprises a painted material having light-reflecting properties. Thus, for example, the painted material comprises a paint which is substantially white in colour so as to provide reflection of light from the light source provided in the cavity, such as the light from LEDs 206 and 207. This allows for the required luminosity from the light source to be achieved in line with the require applications.

In the embodiment shown, cavity 205 is shown in an open configuration, however, in use, the lighting panel comprises additional components including, but not limited to diffusers, light guide plate(s) and reflector plate(s) to ensure a desirable light output from the lighting panel. In addition, housing 201 is typically fitted to a frame which supports each of the additional components in housing 201.

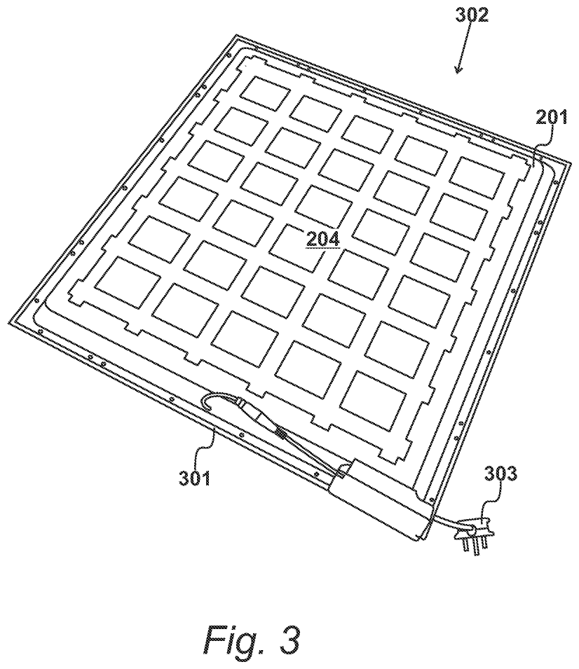

### FIG. 3

The lighting panel of FIG. 2 is shown in an alternative orientation depicting rear surface 204 of housing 201. Housing 201 is fitted to frame 301 which provides support for the internal lighting components positioned in cavity 205. Lighting panel 302 includes a power source 303, which, in this illustrated embodiment, provides an electrical mains connection extending through housing 201 to enable lighting panel 302 to be connected to the mains electricity supply.

Rear surface 204 comprises a painted material having light-reflecting properties. In practice, light-reflecting properties are not required on rear surface 204. However, in terms of manufacture of housing 201, it important that the housing, which is typically made from steel, is coated in paint to prevent rust. Thus, as the inside cavity requires a surface having light-reflecting properties, the painted coating for both front surface 203 and rear surface 204 is substantially similar and usually applied at the same point in manufacture. Alternative methods, such as galvanising the housing and therefore front surface 203 and rear surface 204 is not appropriate, as the front surface 203 would further require painting or otherwise to ensure a surface which can appropriately reflect light from the light source. In this way, ensuring fire-resistant properties of the lighting panel and housing in particular can be difficult to achieve without losing luminosity and functionality.

In an embodiment, lighting panel 302 is an LED panel comprising a standard size of one thousand one hundred and ninety-five millimetres (1195 mm) by five hundred and ninety-five millimetres (595 mm). In a further embodiment, lighting panel 302 is an LED panel comprising a standard size of five hundred and ninety-five millimetres (595 mm) by five hundred and ninety-five millimetres (595 mm). It is appreciated that any suitable lighting panel of other dimensions may be utilised in other embodiments.

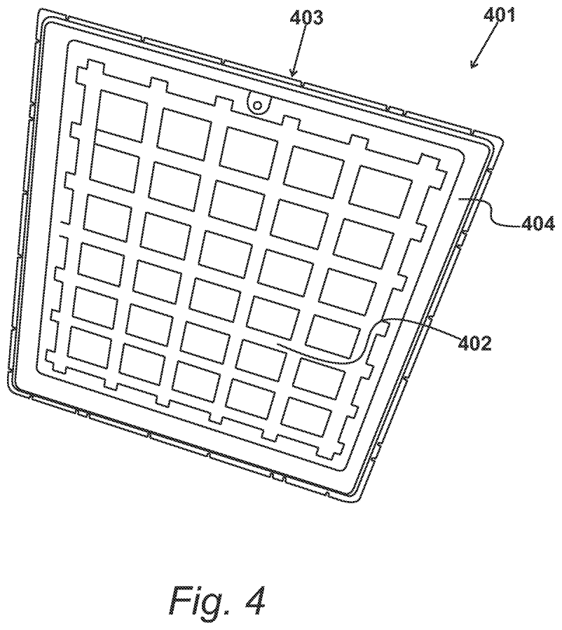

### FIG. 4

The lighting panel described with respect to FIGS. 2 and 3 is configured to be used with cover 401 shown in FIG. 4. It is appreciated that, while cover 401 is configured to be utilised with the lighting panel herein described, alternative lighting panels, which have varying properties, may also be configured to be utilised with appropriate covers having substantially similar functionality as cover 401.

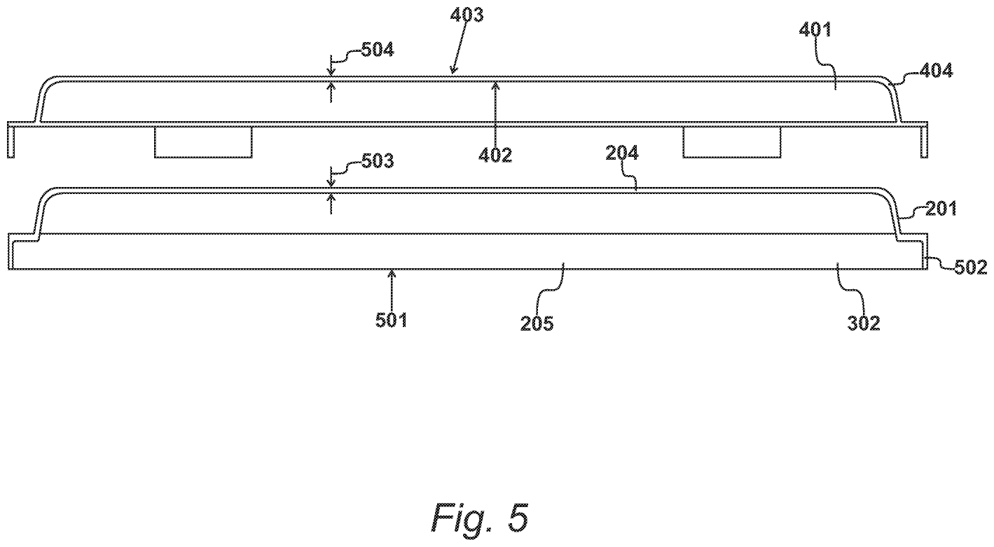

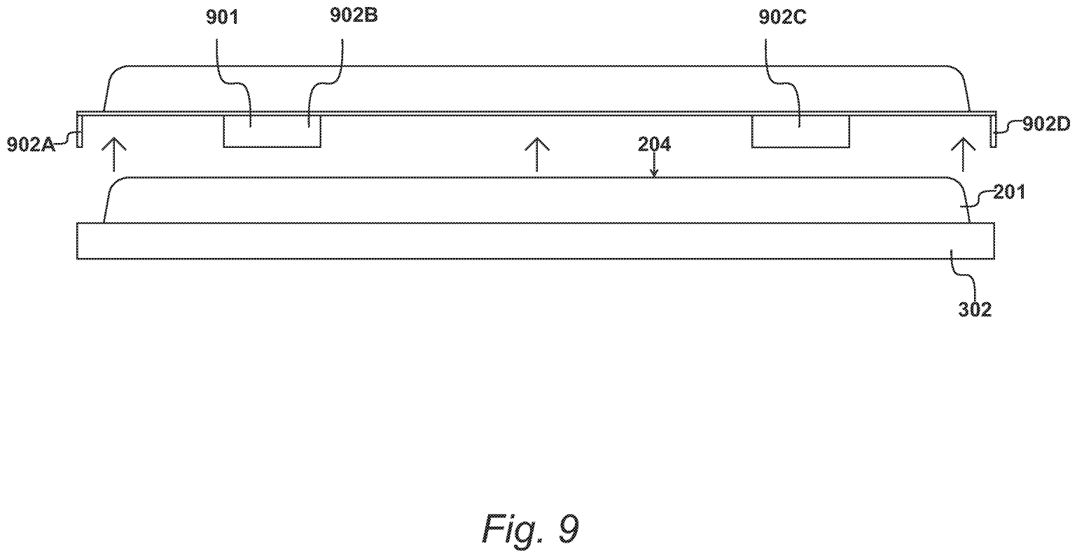

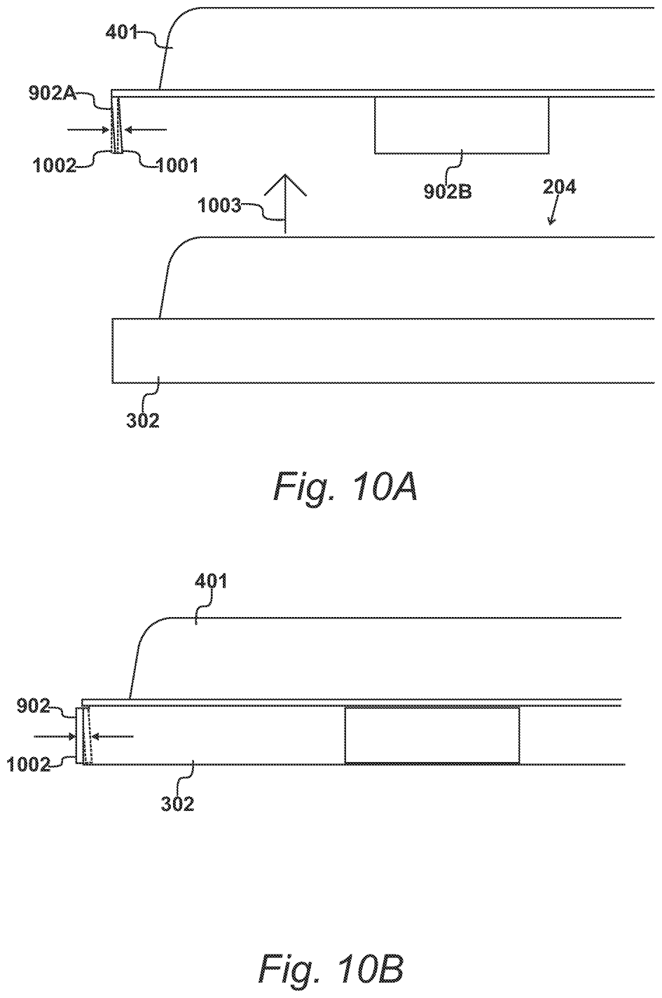

Cover 401 is configured to be securable to rear surface 204 of housing 201, as will be described in further detail in particular with reference to FIGS. 9 and 10. Cover 401 is also conformable to rear surface 204 as will be described further with respect to FIG. 5.

In the embodiment, cover 401 comprises galvanised steel. In a particular embodiment, the galvanised steel is zinc-dipped. In further embodiments, it is anticipated that alternative metallic materials may be utilised, however, it is noted that the galvanised steel embodiment described herein has been tested to meet fire-safety standards in line with BS-476-22:1987 and EN-1364-2:2018.

In the embodiment, cover 401 is sized to conform to conventionally available lighting panels. Thus, in an embodiment, cover 401 has a cross-sectional area of five hundred and ninety-five millimetres (595 mm) by five hundred and ninety-five millimetres (595 mm) and a depth of fifty millimetres (50 mm). In an alternative embodiment, cover 401 has a cross-sectional area of one thousand one hundred and ninety-five millimetres (1195 mm) by five hundred and ninety-five millimetres (595 mm) and a depth of fifty millimetres (50 mm).

Cover 401 comprises an inner surface 402 and an outer surface 403 and is manufactured by means of a sheet metal pressing process in line with conventional practice. Cover 401 is therefore formed by application of a pressure such that an outer wall 404 extends around the edge of both inner surface 402 and outer surface 403 as will be described further with respect to FIG. 5.

### FIG. 5

A cross sectional diagrammatic view of cover 401 and lighting panel 302 is shown in FIG. 5. Housing 201 comprises cavity 205 which comprises a light source within such that light can be emitted from the front 501 when in use. Housing 201 comprises outer wall 502 which defines cavity 205 and houses the light source within. Outer wall 404 comprises a first wall thickness 503.

In the embodiment, cover 401 comprises a substantially similar cross-sectional profile to outer wall 502 and rear surface 204 as shown. In this way, inner surface 402 of cover 401 is configured to conform to the rear surface 204 of housing 201.

Cover 401 comprises outer wall 404 which comprises a second wall thickness 504. In the embodiment, first wall thickness 503 and second wall thickness 504 are substantially similar in dimension. In use, cover 401 fits over lighting panel 302 so as to provide increased fire protection. Thus, when fitted to a ceiling as per the example of FIG. 1, outer surface 403 provides an additional layer of protection to lighting panel 302.

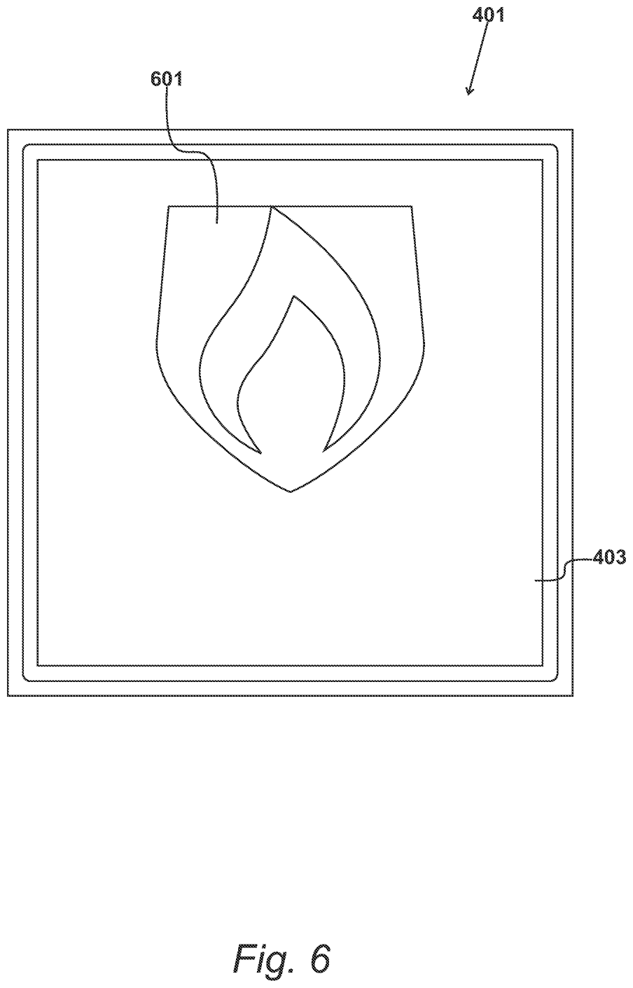

### FIG. 6

A plan view of cover 401 depicting outer surface 403 is shown in FIG. 6.

In the embodiment, outer surface 403 of cover 401 is imprinted with a visual indentation 601. In manufacture therefore, cover 401 is manufactured by means of a conventional sheet metal pressing process which stamps visual indentation 601 onto cover 401. In this way, branding or other indications can be incorporated onto outer surface 403. In further embodiments, this includes instructions for fitting cover 401 to existing lighting panels.

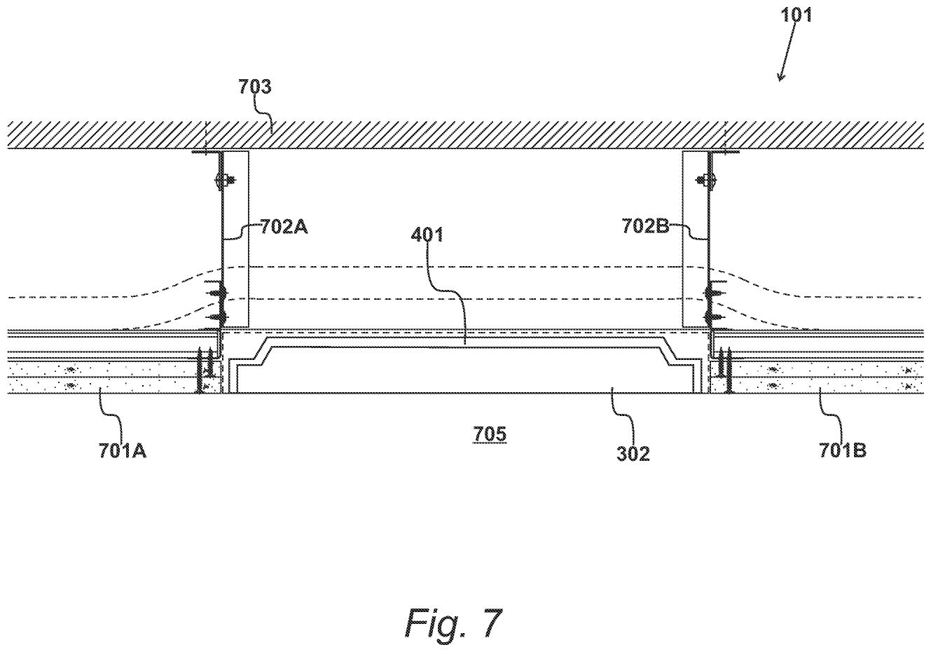

### FIG. 7

An illustration of a lighting panel fitted to a ceiling with a cover in place is shown in FIG. 7. FIG. 7 shows a cross-sectional schematic of a ceiling, such as ceiling 101 previously described in FIG. 1.

Ceiling 101 comprises a plurality of ceiling boards 701 which surround lighting panel 302 and cover 401 in situ. Ceiling 101 is arranged such that support frames 702 are attached to building 703. Support frames 702 therefore provide support to ceiling boards 701 to hold in place.

In the embodiment, lighting panel 302 is further attached to ceiling boards 701 and cover 401 is attached to lighting panel 302 in place. Thus, in the event of fire in building 101, and in particular in area 704, cover 401 provides protection of lighting panel 302 by encasing rear surface 204 of lighting panel 302. This may further prevent fire escaping through lighting panel 302 in a room 705.

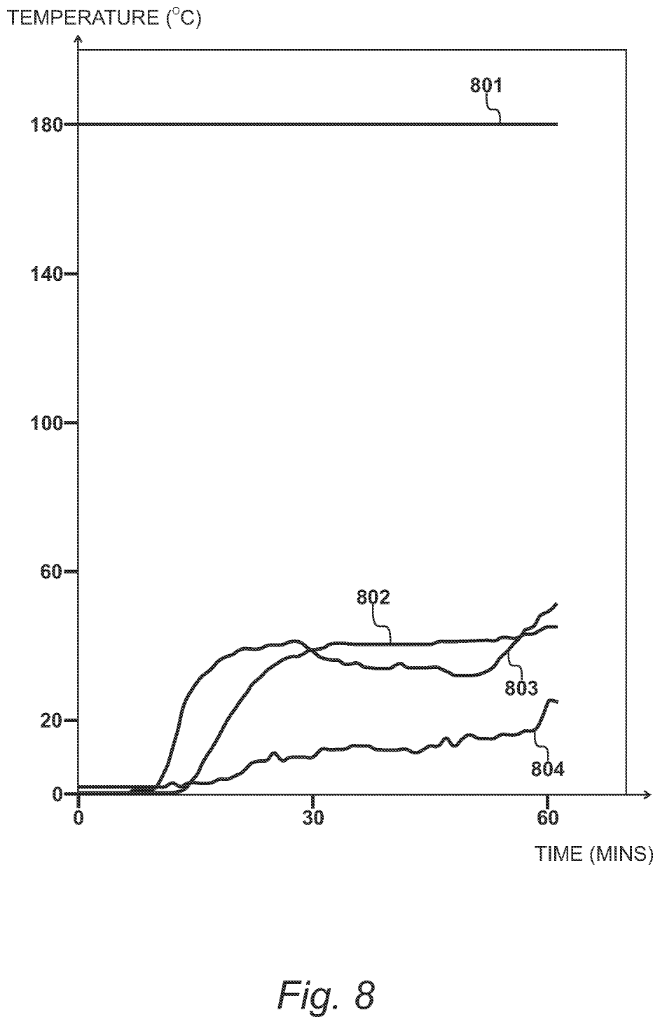

### FIG. 8

An initial prototype of cover 401 has been tested in line with fire safety standards of BS-476-22:1987 and EN-1364-2:2018. FIG. 8 shows a plot of temperature change against time for a conventional lighting panel used with a cover in accordance with the invention described herein.

Graph 801 provides a maximum temperature limit of one hundred and eighty degrees Celsius (180°) which a lighting panel of this type may be subjected to. Graphs 802, 803 and 804 provide three separate results highlighting the variation of temperature of the lighting panel when subjected to a conventional fire test in accordance with BS-476-22:1987 and EN-1364-2:2018 for sixty minutes.

FIG. 8 therefore shows that in each test, the lighting panel tested, in combination with a cover as described herein, reached maximum temperatures of under sixty degrees Celsius (60° C.) during the tests. This is well within the maximum one hundred and eighty degrees Celsius (180°) limit illustrated.

### FIG. 9

Cover 401 is securable to rear surface 204 of housing 201 of lighting panel 302 in the manner as will now be described with respect to FIGS. 9 and 10.

In the embodiment, cover 401 is provided with a securing means 901 configured to secure cover 401 to housing 201. In the embodiment shown, securing means 901 comprises at least one flexible tab, and in this embodiment, comprises a plurality of flexible tabs 902. The plurality of flexible tabs 902 are spaced around an outer edge of cover 401 at desired intervals. Each flexible tab 902 is resiliently biased such that, when fitted to housing 201, each tab 902 grips the housing 201. This will be described further with respect to FIG. 10.

### FIGS. 10A and 10B

FIGS. 10A and 10B illustrate the process of securing lighting panel 302 to cover 401 by means of the securing means comprising a plurality of flexible tabs.

FIGS. 10A and 10B illustrate a portion of lighting panel 302 and cover 401, in an exploded view in FIG. 10A and secured together in FIG. 10B.

Referring to FIG. 10A, and in particular flexible tab 902A, each flexible tab 902 is resiliently biased towards the inner surface of cover 401. Thus, when unfitted, as per FIG. 10A, flexible tab 902A has orientation 1001, shown in a solid line. However, flexible tab 902A is configured to be able to move to orientation 1002, shown in a dashed line, under, for example, the force from lighting panel 302. Flexible tab 902A however is biased towards orientation 1001, such that, when not subjected to an external force, will flex into the position of orientation 1001.

Lighting panel 302 is secured to cover 401 by moving lighting panel 302 in the direction of arrow 1003 such that the rear surface 204 is pushed closer to cover 401 such that it comes into contact with inner surface 402 of cover 401.

Thus, FIG. 10B shows cover 401 now secured to lighting panel 302. Having been brought together, flexible tab 902A moves towards orientation 1002, now shown in a solid line, away from the resiliently biased orientation 1001. However, as flexible tab 902A remains resiliently biased, flexible tab 902A snaps towards lighting panel 302 and grips onto lighting panel 302 to secure cover 401 to lighting panel 302. The plurality of flexible 902 each provide a substantially similar mechanism so as to secure cover 401 in place.

It is appreciated that, in alternative embodiments, other securing means are utilised. For example, in a further embodiment, the securing means comprises a fastener. In an embodiment, the fastener comprises a clip mechanism and may include conventional clips configured to slide onto cover 401 and lighting panel 302 to hold cover 401 and lighting panel 302 together. In a further embodiment, the fastener comprises a plurality of screws which are utilised to secure cover 401 and lighting panel 302 together in a conventional manner.

I/we claim:

1. Apparatus for providing a light source to a building, comprising:
a lighting panel comprising a housing comprising an outer wall, having a front surface and a rear surface;
said front surface defining a cavity, said cavity comprising a light source therein;
wherein said apparatus further comprises a galvanised steel cover, securable to said rear surface of said housing, said cover being configured to conform to said rear surface of said housing.

2. Apparatus according to claim 1, wherein said cover is zinc-dipped.

3. Apparatus according to claim 1, wherein said housing comprises a first thickness and said cover comprises a second thickness; said first thickness and said second thickness being substantially similar.

4. Apparatus according to claim 1, further comprising a securing means for securing said cover to said housing.

5. Apparatus according to claim 4, wherein said securing means comprises a flexible tab.

6. Apparatus according to claim 5, wherein said flexible tab is resiliently biased such that, when fitted to said housing, said flexible tab grips said housing.

7. Apparatus according to claim 4, wherein said securing means comprises a fastener.

8. Apparatus according to claim 7, wherein said fastener comprises a clip mechanism.

9. Apparatus according to claim 7, wherein said fastener comprises a plurality of screws.

10. Apparatus according to claim 1, wherein said front surface and said rear surface comprise a painted material having light-reflecting properties.

11. Apparatus according to claim 1, wherein said cover further comprises a visual indentation.

12. A building comprising a ceiling comprising the apparatus of claim 1.

13. A method of manufacturing an apparatus for providing a light source to a building, comprising the steps of:
obtaining a lighting panel comprising a housing comprising an outer wall having a front surface and a rear surface, said front surface defining a cavity comprising a light source therein;
obtaining a sheet of galvanised steel;
performing a pressing process such that said sheet forms a cover configured to conform to said rear surface of said housing; and
securing said cover to said housing such that said cover conforms to said rear surface of said housing.

14. The method of claim 13, further comprising the step of:
painting said front surface and said rear surface of said housing with a paint comprising light-reflecting properties.

15. The method of claim 13, wherein said step of securing comprises securing said cover to said housing by means of a fastener.

16. The method of any one of claim 13, wherein said step of performing a pressing process further comprises pressing a visual indentation into said sheet.
